(19) United States
(12) Patent Application Publication
(10) Pub. No.: US 2005/0036880 A1
(43) Pub. Date: Feb. 17, 2005

(54) Pallet truck with reinforced fork weldment

(76) Inventors: Daniel Carl Magoto, Russia, OH (US); Timothy Scott Quellhorst, New Bremen, OH (US); Douglas Mark Bornhorst, New Bremen, OH (US)

Correspondence Address: STEVENS & SHOWALTER LLP, 7019 CORPORATE WAY, DAYTON, OH, 45459-4238, US

(21) Appl. No.: 10/911,272

(22) Filed: Aug. 4, 2004

Related U.S. Application Data
(60) Provisional application No. 60/493,403, filed on Aug. 7, 2003.
(60) Provisional application No. 60/494,639, filed on Aug. 12, 2003.

(51) Int. Cl. B66C 3/00

(52) U.S. Cl. 414/785

(57) ABSTRACT

A pallet truck is provided comprising: a power unit including an operator's compartment, and a battery compartment; a fork lifting mechanism coupled to the power unit; and a fork assembly including a fork weldment coupled to the fork lifting mechanism. The fork weldment comprising a pair of forks, each having a working length so as to be capable of supporting at least two pallets substantially in-line with one another.

### CROSS-REFERENCE TO RELATED APPLICATIONS

This application claims the benefit of each of the following Provisional Applications: 1) U.S. Ser. No. 60/493,403, filed Aug. 7, 2003, and entitled PALLET TRUCK WITH REINFORCED FORK WELDMENT, and 2) U.S. Ser. No. 60/494,639, filed Aug. 12, 2003, and entitled PALLET TRUCK WITH REINFORCED FORK WELDMENT, both of which are incorporated herein by reference.

### BACKGROUND OF THE INVENTION

Pallet trucks are known in the prior art comprising fork weldments including a pair of forks capable of supporting one, two in-line or three in-line standard size pallets, i.e., 40 inches×48 inches. However, those trucks are typically limited to loads of approximately 8000 pounds. Further, the battery providing energy for such a truck weighs up to about 1500 pounds and is housed on the fork weldment such that the power unit is required to lift the battery when raising the forks and any load positioned thereon. One advantage to housing the battery on the fork weldment is that it acts as a weight to ensure that the fork weldment is lowered when empty via gravity when desired thus allowing the use of a single-acting cylinder.

There is a need for a pallet truck capable of supporting two or three pallets positioned in-line with one another and supporting up to 15,000 pounds.

### SUMMARY OF THE INVENTION

This need is met by the present invention, wherein the battery is housed in the power unit, i.e., the battery is no longer positioned on the fork weldment. Further, the fork weldment comprises either double-length or triple-length forks and is structurally reinforced so as to allow the forks to support higher loads, e.g., up to approximately 15,000 pounds. Hence, in the present invention, the battery is not supported on the fork weldment and additional structural reinforcement has been added such that the fork weldment is capable of supporting up to about 15,000 pounds, yet the fork weldment per se has a weight less than that of the prior art double-length and triple-length fork weldment/battery combinations. In this way, the present invention provides a more robust fork weldment by incorporating structural reinforcement into the weldment while reducing the overall weight that the power unit must lift. Accordingly, the size of the hydraulic motor/pump unit required to raise and lower the fork weldment can be limited to one required to raise only the weight of the reinforced fork weldment plus a load of up to 15,000 pounds, i.e., it is not required to raise an additional load equal to that of a battery weighing up to about 1500 pounds. The present invention also contemplates providing the fork weldment with a fork support structure, i.e., structure which couples the forks together and maintains them in a desired physical orientation relative to one another, having a length in a machine direction which is minimized, e.g., less than 12 inches, so as to reduce the overall length of the pallet truck.

### BRIEF DESCRIPTION OF THE DRAWINGS

FIG. 1 is a view of a first side of a pallet truck constructed in accordance with a first embodiment of the present invention;

FIG. 2 is a front view of the truck illustrated in FIG. 1;

FIG. 3 is a view of a second side of the pallet truck illustrated in FIG. 1;

FIG. 4 is a schematic top view of the truck illustrated in FIG. 1 with the fork weldment removed;

FIG. 5 is a rear view of the truck illustrated in FIG. 1;

FIG. 6 is a perspective view of the power unit of the truck illustrated in FIG. 1;

FIG. 7 is a perspective view of the fork weldment coupled to the power unit of the truck illustrated in FIG. 1;

FIG. 7A is an end view of a portion of the fork weldment illustrating a first end of the first fork;

FIG. 7B is a perspective view of an end of the fork weldment;

FIG. 7C is an end view of the fork weldment;

FIG. 7D is an end view of a fork, a corresponding pair of L-shaped support members and a corresponding pair of hollow support bodies;

FIG. 7E is a plan view of a bottom support plate forming part of the fork weldment;

FIG. 7F is a perspective view of an upper assembly forming part of the fork weldment;

FIG. 7G is a perspective view of a portion of the fork weldment, wherein the fork weldment is shown not coupled to the power unit;

FIG. 7H is a perspective view of a first load wheel assembly;

FIG. 8 is a top view illustrating a second upper link and second lower link of a four bar linkage assembly of the truck illustrated in FIG. 1;

FIG. 8A is a schematic perspective view of a fork lifting mechanism of the truck illustrated in FIG. 1:

FIG. 8B is a schematic perspective view of the fork lifting mechanism of the truck illustrated in FIG. 1; wherein the FIG. 8B view is rotated approximately 180° from the FIG. 8A view;

FIG. 9 is a top view illustrating a first upper link and first lower link of the four bar linkage assembly of the truck illustrated in FIG. 1;

FIG. 10 is a perspective view of a piston/cylinder unit of the fork lifting mechanism of the truck illustrated in FIG. 1; and

FIG. 11 is a view of a first side of a pallet truck constructed in accordance with a second embodiment of the present invention.

### DETAILED DESCRIPTION OF THE INVENTION

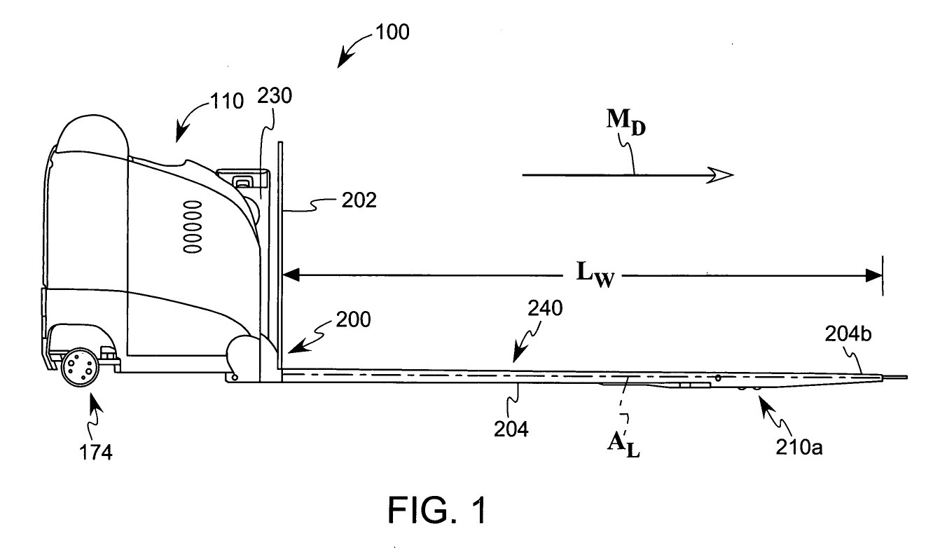

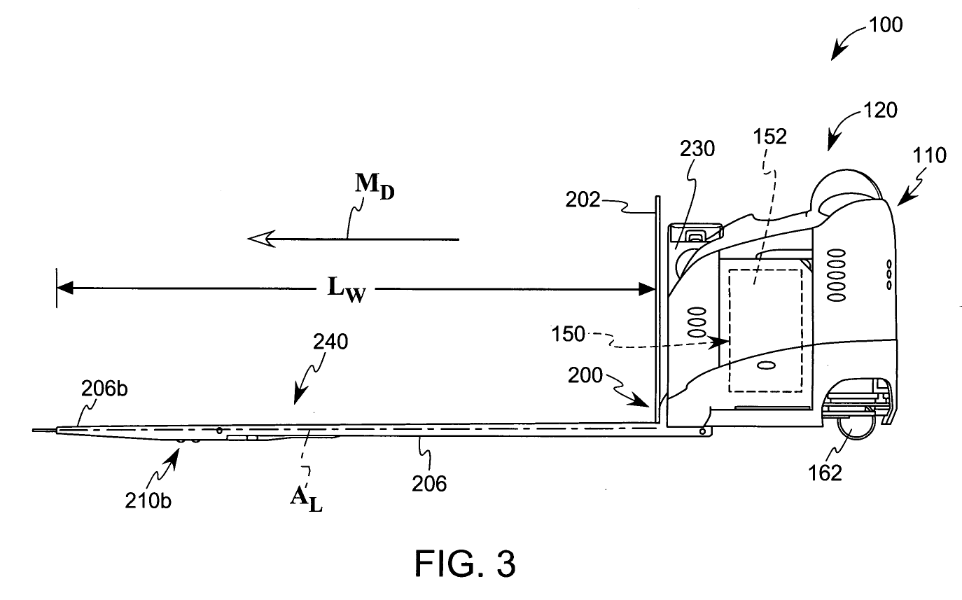

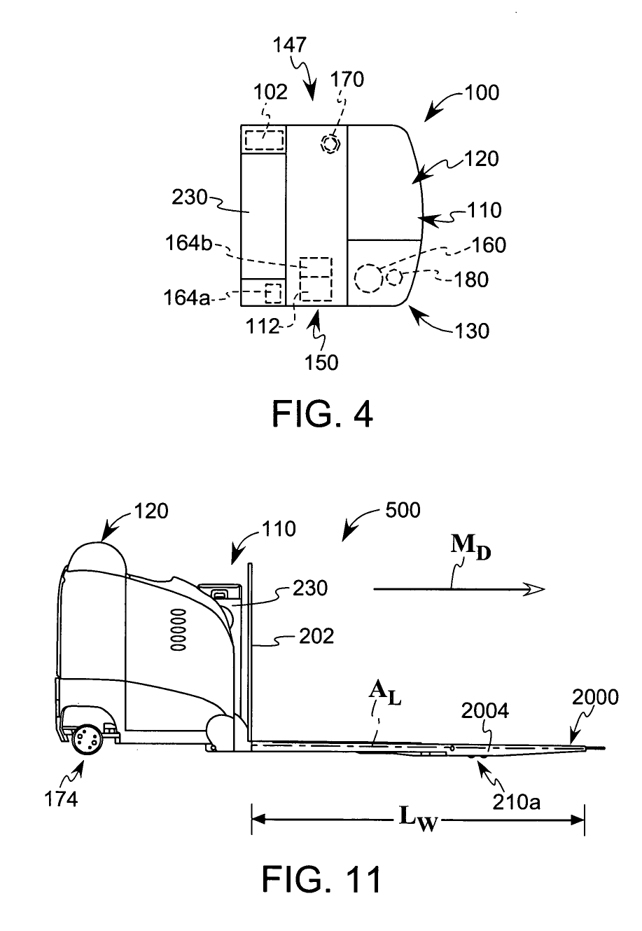

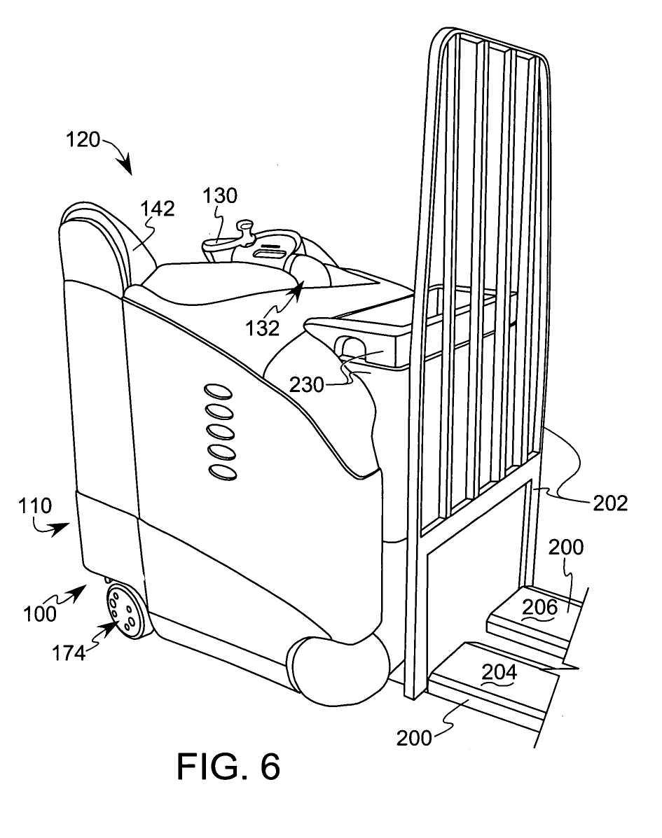

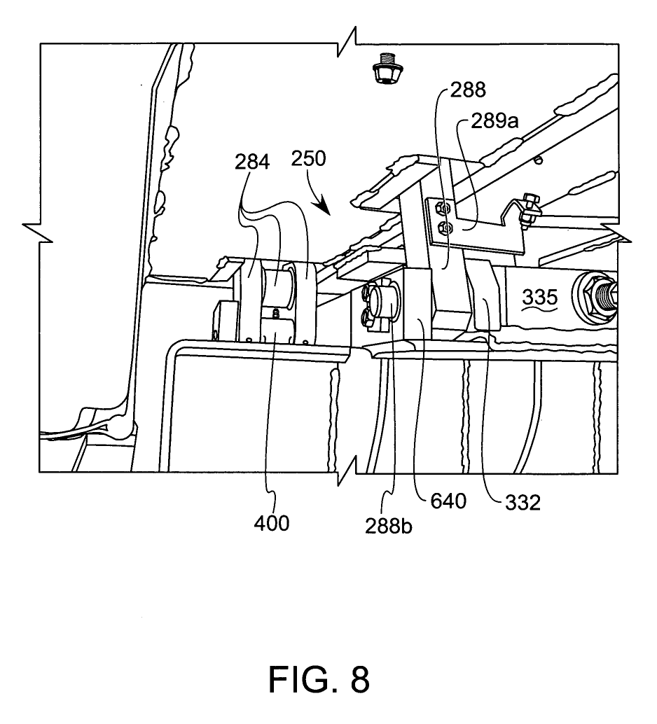

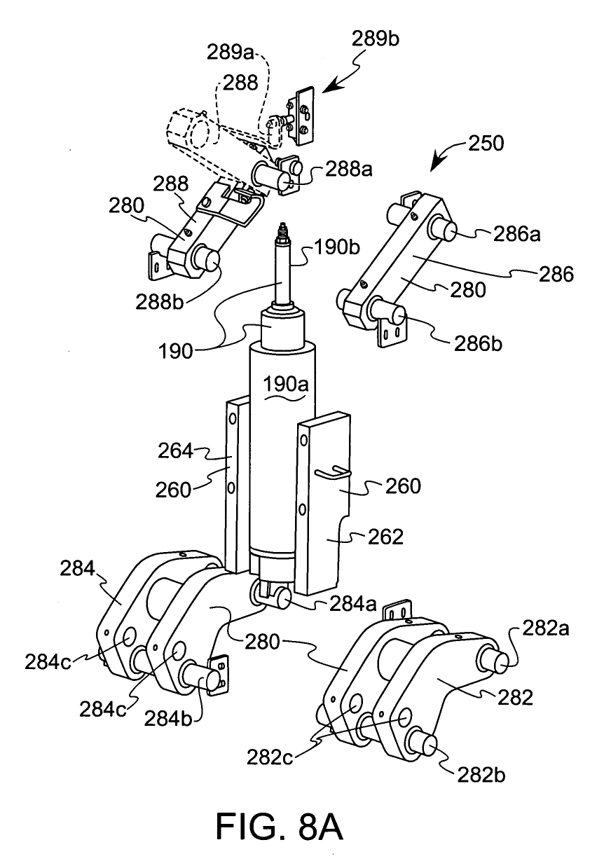

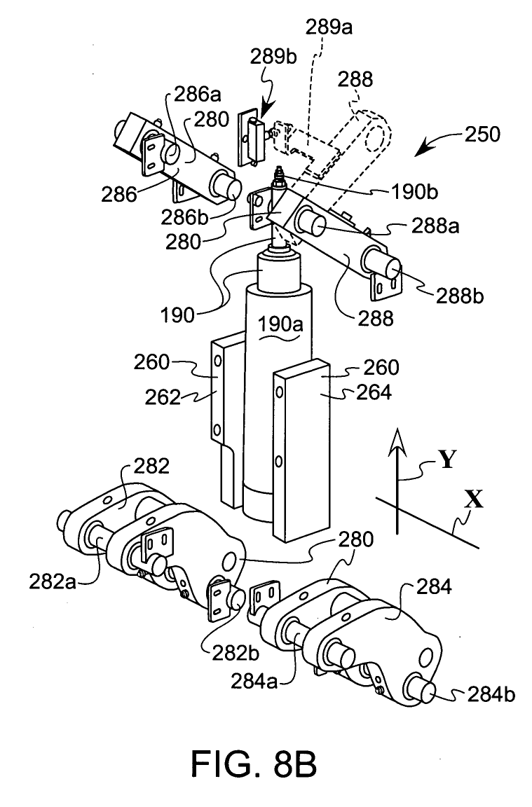

A pallet truck 100 constructed in accordance with a first embodiment of the present invention is illustrated in FIGS. 1-6. The truck 100 includes a power unit 110 comprising an operator's compartment 120, see FIG. 4, a drive motor compartment 130, a hydraulic motor compartment 147, and a battery compartment 150 located forward of the operator's compartment 120, see FIG. 3. A battery 152 is housed within the compartment 150. It supplies power to a traction motor/brake assembly 160, shown in phantom in FIG. 4, housed within the drive motor compartment 130, and a hydraulic motor/pump assembly 170, also shown in phantom in FIG. 4, housed with the hydraulic motor compartment 147. The assembly 170 supplies power or pressurized fluid to a fork-lifting hydraulic piston/cylinder unit 190, see FIGS. 8A and 8B, and a power steering motor 180. Fluid for the assembly 170 is supplied by fluid reservoir 102, see FIG. 4. The operation of the assembly 170 is controlled via a flat-pack electronic controller 112. The traction motor/brake assembly 160, a steerable wheel 162 driven by the assembly 160 and a pair of flat-pack traction motor/brake assembly electronic controllers 164a and 164b define a drive mechanism for effecting movement of the truck 100. A non-driven, brakable caster wheel assembly 174 is placed at the right rear of the truck 100, see FIGS. 1 and 6.

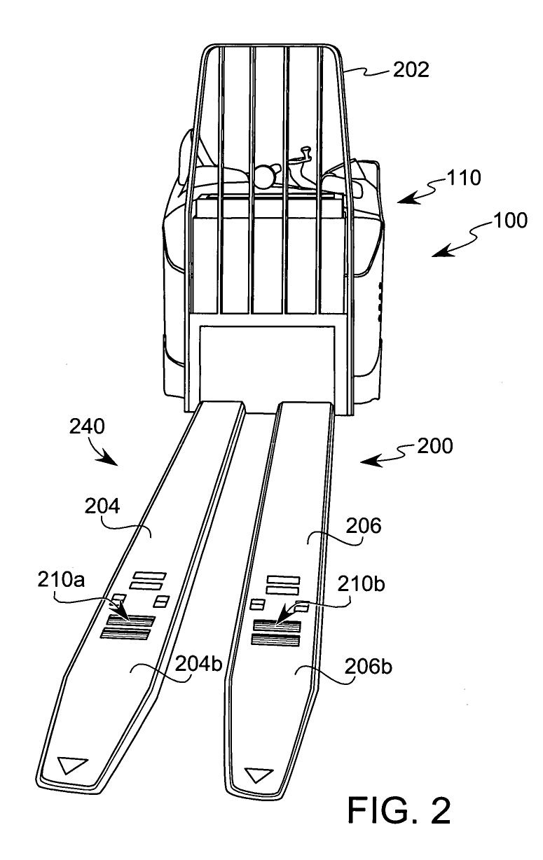

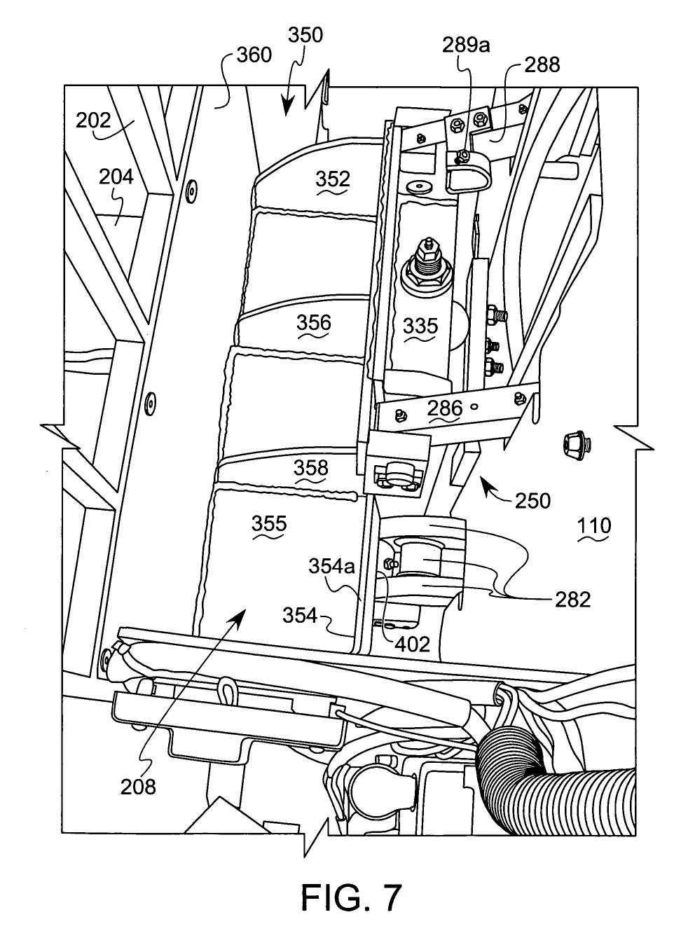

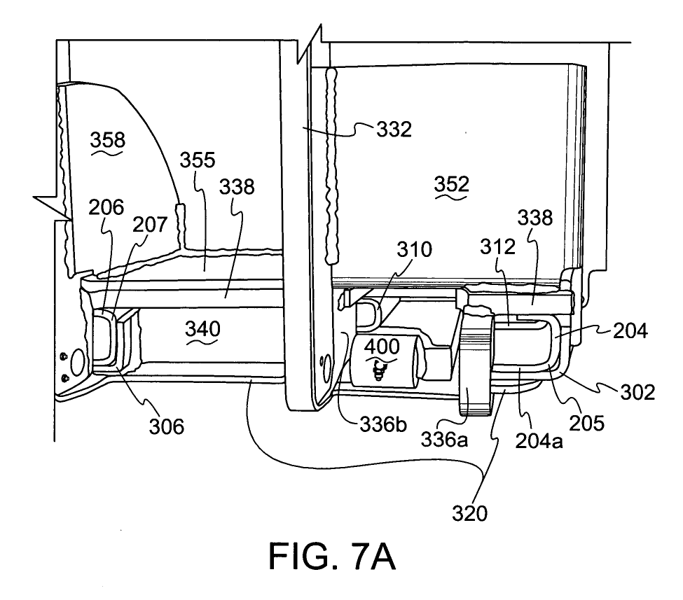

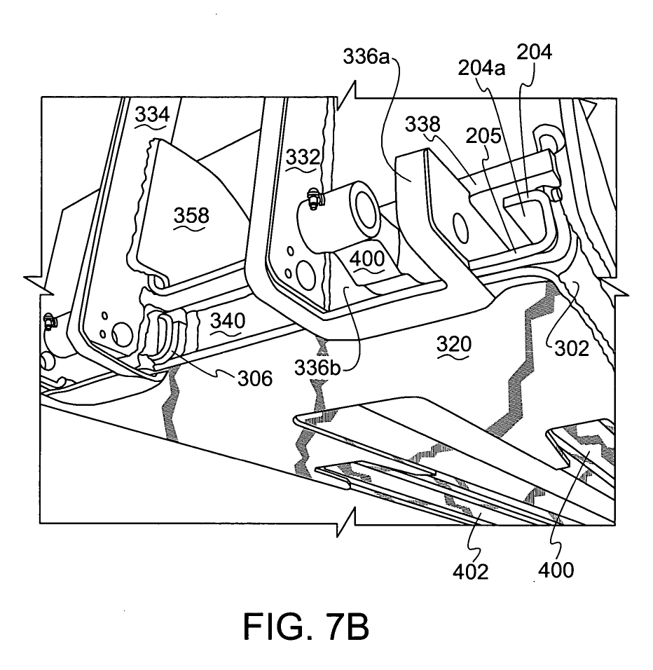

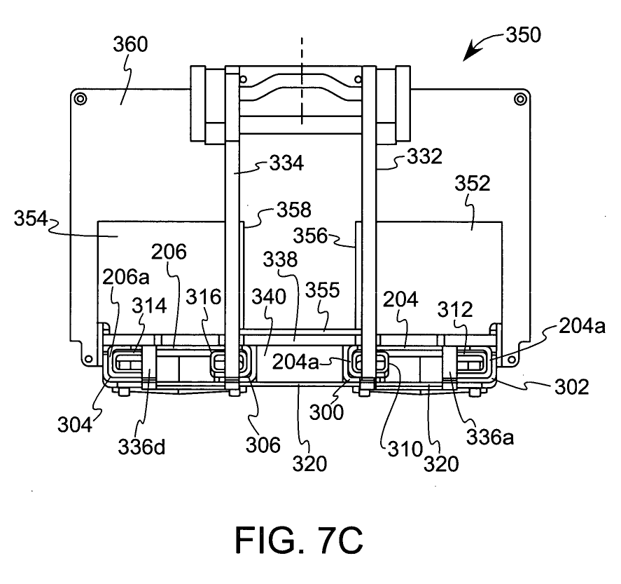

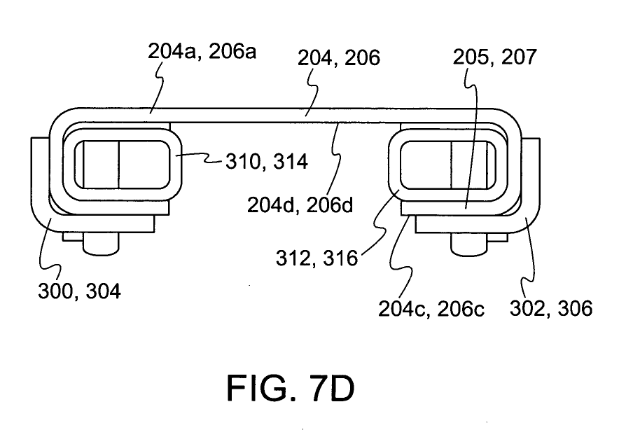

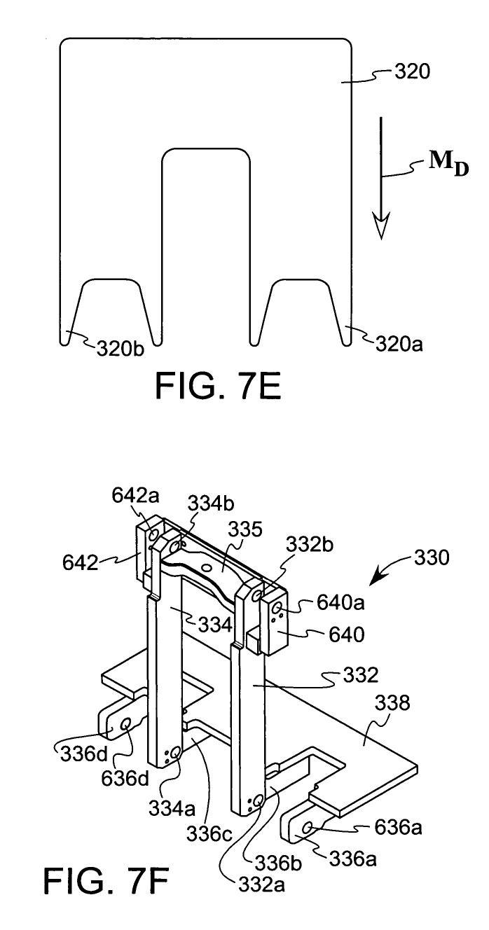

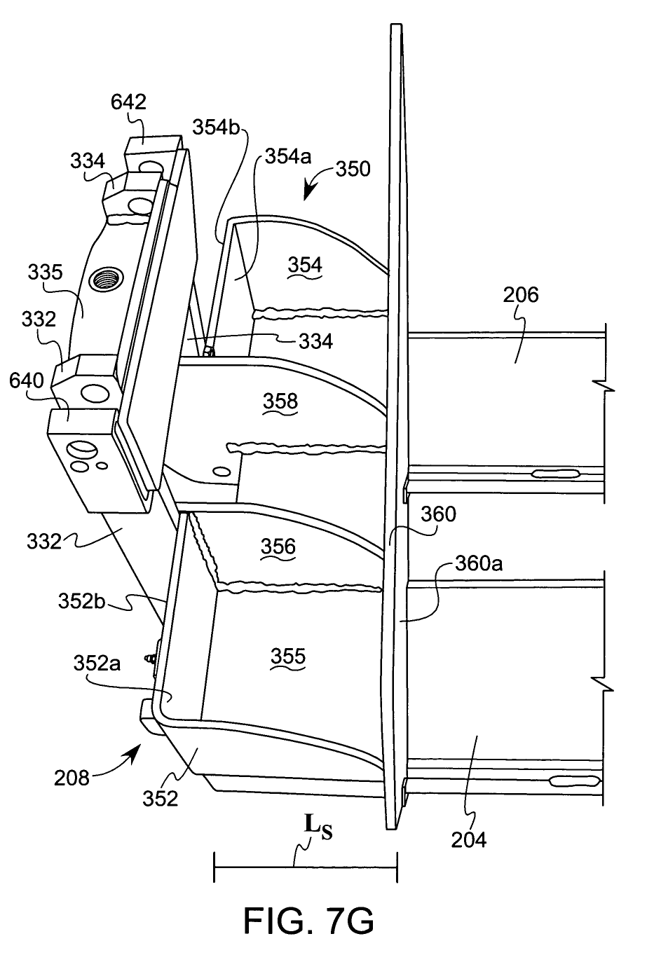

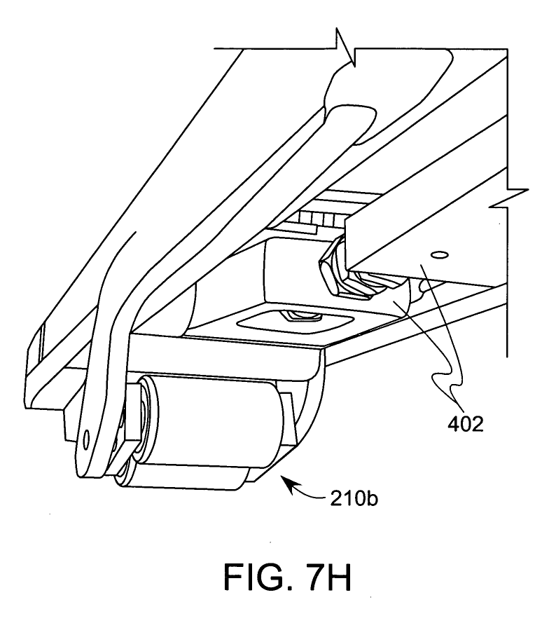

The pallet truck 100 further includes a fork weldment 200 comprising first and second forks 204 and 206, and a fork support structure 208 for maintaining the forks 204 and 206 in a fixed, parallel orientation relative to one another, see FIGS. 1-3 and 7 (the weldment 200 is not shown in FIG. 4; the support structure 208 is illustrated in FIG. 7). A backrest 202 is coupled to the fork weldment 200, see FIG. 1. Each of the forks 204 and 206 has a longitudinal axis A_{L} extending in a machine direction M_{D} and further has a working length L_{W} extending from the backrest 202, see FIGS. 1 and 2, along its longitudinal axis A_{L} of about 140.75 inches so as to be capable of supporting at least three pallets (not shown) positioned substantially in-line with one another. It is contemplated that two vertical rows of three in-line pallets (not shown) may be lifted and transported by the forks 204 and 206. It is additionally contemplated that the forks 204 and 206 may lift and transport a combined load of up to about 15,000 pounds.

The first and second forks 204 and 206 are coupled at their first ends 204a and 206a to the fork support structure 208, see FIGS. 7, 7A-7G. The fork support structure 208 is located behind a removable cover 230, see FIGS. 1, 3, 4 and 6. The backrest 202 is also coupled to the fork support structure 208.

The fork support structure 208 comprises first and second generally L-shaped steel members 300 and 302, each having a wall thickness of approximately 0.38 inch, which members 300 and 302 extend from a rear edge 205, see FIGS. 7A and 7B, of the first fork 204 and are weldably coupled to a lower surface 204c of the first fork 204, see FIG. 7D, and third and fourth generally L-shaped steel members 304 and 306, each having a wall thickness of approximately 0.38 inch, which members 304 and 306 extend from a rear edge 207, see FIG. 7A, of the second fork 206 and are weldably coupled to a lower surface 206c of the second fork 206, see FIG. 7D; see also FIG. 7C. The first, second, third and fourth L-shaped members 300, 302, 304 and 306 have a length extending in the machine direction M_{D} of about 91.25 inches. The support structure 208 further comprises first and second generally rectangular, hollow support bodies 310 and 312, each having a wall thickness of about 0.25 inch, which members 310 and 312 are spaced approximately 4.75 inches in the machine direction M_{D} from the first fork rear edge 205 and are weldably coupled to an inner surface 204d of the first fork 204, and third and fourth generally rectangular, hollow support bodies 314 and 316, each having a wall thickness of about 0.25 inch, which members 314 and 316 are spaced approximately 4.75 inches in the machine direction M_{D} from the second fork rear edge 207 and are weldably coupled to an inner surface 206d of the second fork 206, see FIGS. 7C and 7D. The first, second, third and fourth generally rectangular, hollow support bodies 310, 312, 314 and 316 have a length extending in the machine direction M_{D} of about 96.31 inches. A bottom support plate 320, having a thickness of approximately 0.25 inches, is weldably coupled to the first, second, third and fourth L-shaped members 300, 302, 304, and 306, see FIGS. 7B and 7E. The plate 320 has a generally horse-shoe shape with recessed end regions 320a and 320b and extends from the rear edges 205 and 207 of the forks 204 and 206 in the machine direction M_{D} approximately 26.25 inches, see FIG. 7E.

The fork support structure 208 further includes an upper assembly 330, see FIG. 7F, comprising first and second generally vertical support members 332 and 334, first, second, third and fourth generally horizontal support members 336a-336d and a generally horizontal reinforcement plate 338. The vertical support members 332 and 334 and the first, second, third and fourth support members 336a-336d are weldably coupled to the reinforcement plate 338. The vertical support members 332 and 334 are additionally weldably coupled to the bottom support plate 320. The first support member 336a is additionally weldably coupled to the bottom support plate 320, the fork 204, and the L-shaped member 302. The second support member 336b is additionally weldably coupled to the bottom support plate 320, the fork 204, and the L-shaped member 300. The third support member 336c is additionally weldably coupled to the bottom support plate 320, the fork 206 and the L-shaped member 306. The fourth support member 336d is additionally weldably coupled to the bottom support plate 320, the fork 206, and the L-shaped member 304.

First and second generally rectangular support blocks (only first block 340 is illustrated in the drawings), see FIGS. 7B and 7C, are positioned between and weldably coupled to the L-shaped members 300 and 306. The support blocks are also weldably coupled to the bottom support plate 320, and the plate 338.

So as to add still additional support to the fork support structure 208, a gusset plate assembly 350 is weldably coupled to the reinforcement plate 338 and the vertical support members 332 and 334, see FIGS. 7, 7C and 7G. The assembly 350 comprises first and second generally L-shaped members 352 and 354 weldably coupled to the vertical support members 332 and 334, respectively, and integral with a base plate 355. The first and second generally L-shaped members 352 and 354 are also weldably coupled to the L-shaped member 302 and the L-shaped member 304, respectively. The base plate 355 is weldably coupled to the reinforcement plate 338 and the vertical support members 332 and 334. The assembly 350 further comprises first and second gusset plate members 356 and 358. The first plate 356 is weldably coupled to the base plate 355 and the support member 332, while the second plate 358 is weldably coupled to the base plate 355 and the support member 334. A generally vertical backing plate 360, upon which the backrest 202 rests and to which the backrest 202 is coupled, is weldably coupled to the L-shaped members 352 and 354 and the gusset plate members 356 and 358.

The fork support structure 208 has a length Ls extending from an outermost surface 360a of the backing plate 360 to outer surfaces 352b and 354b of walls 352a and 354a of the generally L-shaped members 352 and 354 equal to approximately 9.54 inches such that the overall length of the truck 100 in the machine direction D_{M} is limited, see FIG. 7G. The length L_{S} may be less than 12 inches and is preferably less than 10 inches.

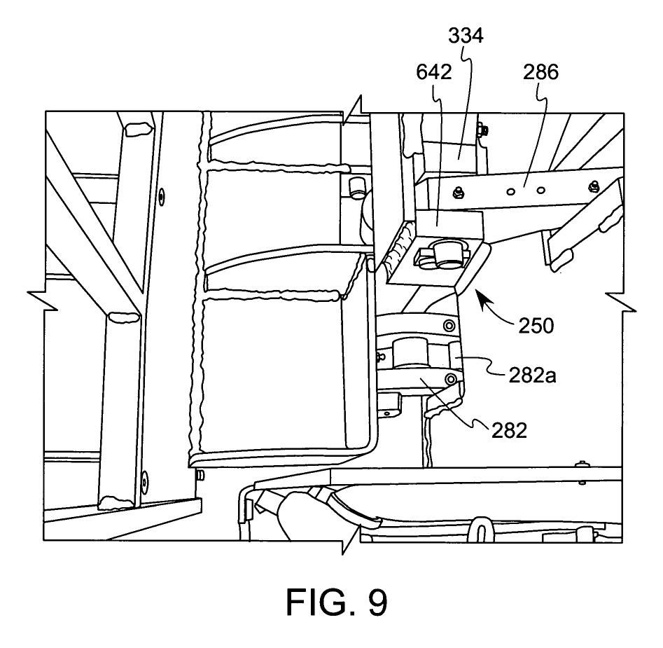

The pallet truck 100 additionally includes a fork lifting mechanism 250 coupled to the power unit 110 and the fork weldment 200, see FIGS. 7, 8, 8A, 8B, 9 and 10. The fork lifting mechanism 250 comprises first structure 260 fixedly coupled to the power unit 110, a four bar linkage assembly 280 coupled to the power unit 110 and the fork support structure 208, and the fork-lifting hydraulic piston/cylinder unit 190 for effecting movement of the fork support structure 208 and, hence, the fork weldment 200 relative to the first structure 260 and the power unit 110.

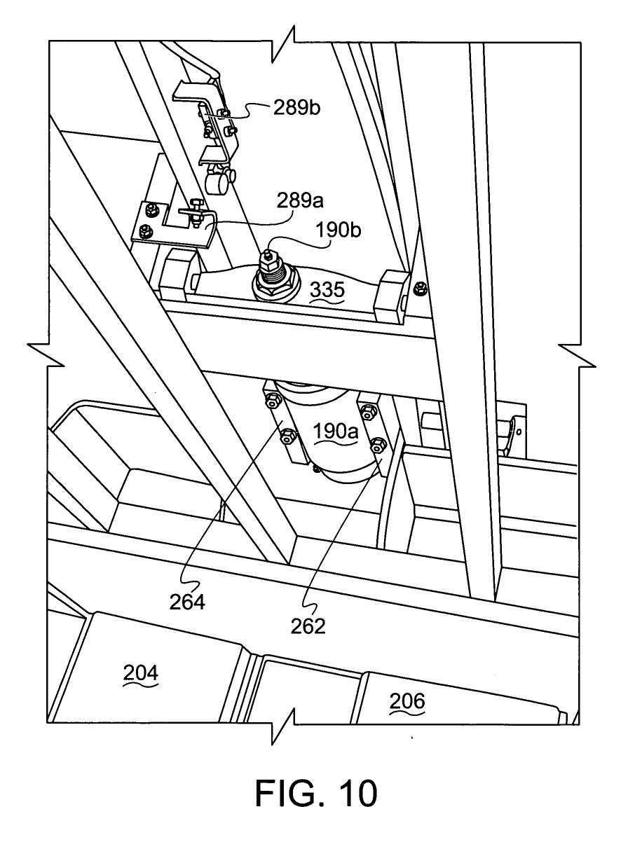

The first structure 260 comprises first and second substantially vertical support blocks 262 and 264 bolted or otherwise fixedly coupled to the power unit 110, see FIGS. 8A, 8B and 10. In FIGS. 8A and 8B, the power unit 110 and the fork weldment 200 are not illustrated. FIGS. 8A and 8B are schematic views, with FIG. 8A being rotated approximately 180 degrees from that of FIG. 8B. The cylinder 190a of the piston/cylinder unit 190 is pivotably coupled to the support blocks 262 and 264 such that the cylinder 190a is capable of pivoting slightly about a substantially horizontal axis in the X-direction, see FIG. 8B. The cylinder 190a is not capable of moving in the Y-direction, see FIG. 8B.

The four bar linkage assembly 280 comprises first and second lower links 282 and 284 and first and second upper links 286 and 288. Second upper link 288 is shown in phantom in FIGS. 8A and 8B in an “elevated” condition such that an actuator 289a coupled to the second link 288 actuates a limit switch 289b so as to prevent further upward movement of the piston 190b of the piston/cylinder unit 190. Second upper link 288 is also shown in solid line in FIGS. 8A and 8B in a “down” position, just as the remaining links 282, 284 and 286 are also shown in FIGS. 8A and 8B in solid line in a “down” position.

First power unit pins 282a and 284a and second power unit pins 286a and 288a are fixedly coupled to the power unit 110 so as not to rotate or otherwise move relative to the power unit 110. The first pins 282a and 284a extend through corresponding bushings provided in the first and second lower links 282 and 284 such that the lower links 282 and 284 are able to pivot about the fixed pins 282a and 284a. Likewise, the second pins 286a and 288a extend through corresponding bushings provided in the first and second upper links 286 and 288 such that the upper links 286 and 288 are able to pivot about the fixed pins 286a and 288a.

First fork weldment pins 282b and 284b and second fork weldment pins 286b and 288b are fixedly coupled to the fork weldment 200 so as not to rotate or otherwise move relative to the fork weldment 200. In particular, pin 282b extends through an opening 636d provided in the fourth horizontal support member 336d and a lower opening 334a provided in the second vertical support member 334, see FIG. 7F. The pin 284b extends through an opening 636a provided in the first horizontal support member 336a and a lower opening 332a provided in the first vertical support member 332. The pin 286b extends through an opening 642a provided in an adjacent support member 642 spaced from and fixedly coupled to the second vertical support member 334 and an upper opening 334b provided in the second vertical support member 334. The pin 288b extends through an opening 640a provided in an adjacent support member 640 spaced from and fixedly coupled to the first vertical support member 332 and an upper opening 332b provided in the first vertical support member 332. The first pins 282b and 284b extend through corresponding bushings provided in the first and second lower links 282 and 284 such that the lower links 282 and 284 are able to pivot about the pins 282b and 284b. Likewise, the second pins 286b and 288b extend through corresponding bushings provided in the first and second upper links 286 and 288 such that the upper links 286 and 288 are able to pivot about the pins 286b and 288b.

The piston 190b of the piston/cylinder unit 190 is fixedly coupled to a cross member 335 forming part of the fork support structure upper assembly 330 such that movement of the piston 190b effects movement of the upper assembly 330 and, hence, the fork weldment 200. When pressurized fluid is provided to the piston/cylinder unit 190 via the hydraulic motor/pump assembly 170, the forks 204 and 206 are lifted to an upper level approximately nine inches above the floor. When the forks 204 and 206 reach the upper level, the actuator 289a actuates limit switch 289b causing power to the hydraulic motor/pump assembly 170 to be discontinued. It is also contemplated that an integral actuator/limit switch assembly may be provided (not shown) and coupled to the power unit 110, which switch is actuated by engagement by link 288. In either case, the actuator 289a and the limit switch 289b or the actuator/limit switch assembly are appropriately positioned such that power is discontinued to the assembly 170 at an appropriate time so as to limit the upward movement of the fork weldment 200 as desired. When commanded by an operator, fluid is released from the piston/cylinder unit 190 by appropriate valve structure (not shown) such that the forks 204 and 206 are returned to their lowermost position via gravity. The weight of the fork weldment 200 and any load thereon is typically sufficient to cause the fork weldment 200 to return to its lowermost position. However, it is contemplated that a small amount of weight, e.g., 100 pounds, may be coupled to the fork weldment 200 so as to ensure that it falls under the force of gravity when 0 or a minimal load is on the forks 204 and 206 and commanded by an operator.

Coupled to second ends 204b and 206b of the first and second forks 204 and 206 are first and second load wheel assemblies 210a and 210b, see FIGS. 1-3. When the forks 204 and 206 are moved to a raised position, the load wheel assemblies 210a and 210b are caused to pivot relative to the forks 204 and 206. A first linkage rod assembly 400 extends through the first fork 204 and is coupled at a first end to the first load wheel assembly 210a and is coupled at its second end via a pin (not shown) extending through openings 284c in the second lower link 284, see FIGS. 7B, 8 and 8A (the assembly 400 is not shown in FIG. 7C). A second linkage rod 402 extends through the second fork 206 and is coupled at a first end to the second load wheel assembly 210b, see FIG. 7H, and is coupled at its second end via a pin (not shown) extending through openings 282c in the first lower link 282, see FIGS. 7 and 8A. In response to pivotable movement of the first and second lower links 282 and 284, the rod assemblies 402 and 400 are caused to reciprocate. Reciprocating movement of the rod assemblies 400 and 402 causes pivotable movement of the load wheel assemblies 210a and 210b relative to the forks 204, 206 such that the second fork ends 204b and 206b are raised or lowered to a height substantially equal to a height to which the first ends 204a and 206a are raised or lowered by the fork-lifting hydraulic piston/cylinder unit 190. The fork weldment 200 and the load wheel assemblies 210a and 210b define a fork assembly 240.

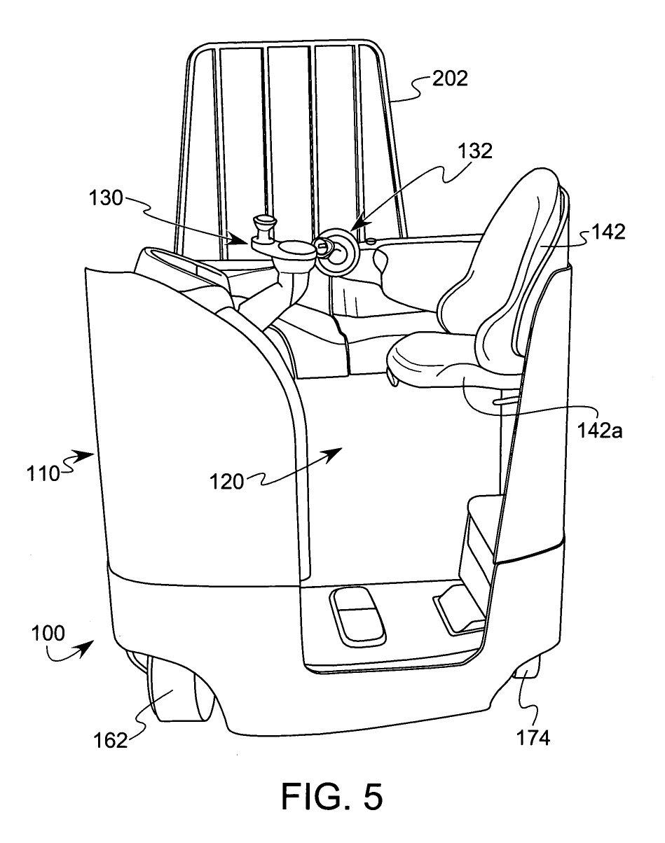

The operator's compartment 120 is placed at the right rear of the truck 100 (with the front of the vehicle being in the direction of the forks 204 and 206), see FIGS. 2 and 4. An operator stands or sits in the compartment 120 with a left hand on a steering control 130 and a right hand on a control handle 132, which controls the vehicle speed, direction of travel, and the raising and lowering of the forks 204 and 206, see FIG. 5. The operator's back is supported by an operator's back rest 142. The operator may sit in the compartment 120 when a pivotable seat 142a is in a down position, as illustrated in FIG. 5.

A pallet truck 500 constructed in accordance a second embodiment of the present invention is illustrated in FIG. 11, wherein like reference numerals indicate like elements. The pallet truck 500 comprises a power unit 110 which is constructed in the same manner as the power unit 110 illustrated in FIG. 4 and used in the truck 100. The truck 500 further comprises a fork weldment 2000 comprising first and second forks 2004 (the second fork is not illustrated in FIG. 11), and a fork support structure (not shown) for maintaining the forks in a fixed, parallel orientation relative to one another. The fork support structure incorporated into the truck 500 is constructed in essentially the same manner as the fork support structure 208 incorporated into the truck 100 illustrated in FIGS. 1-6, except that the first, second, third and fourth L-shaped members 300, 302, 304 and 306 have a length extending in the machine direction M_{D} of about 46.5 inches; the first, second, third and fourth generally rectangular, hollow support bodies 310, 312, 314 and 316 have a length extending in the machine direction M_{D} of about 51.5 inches; and the bottom support plate 320 extends in the machine direction M_{D} approximately 26.25 inches. Otherwise, the elements comprising the fork support structure incorporated into the truck 500 are the same as those used in the truck 100. A backrest 202 is coupled to the fork weldment 2000.

Each of the first and second forks of the truck 500 has a working length L_{W} extending from the backrest 202 along its longitudinal axis A_{L} of about 96 inches so as to be capable of supporting at least two pallets (not shown) positioned substantially in-line with one another. It is contemplated that two vertical rows of two in-line pallets (not shown) may be lifted and transported by the first and second forks. It is additionally contemplated that the forks of the truck 500 may lift and transport a combined load of up to about 15,000 pounds. The truck 500 also includes a fork lifting mechanism which is essentially the same as the mechanism 250 used in the truck 100. Coupled to the second ends of the first and second forks of the truck 500 are first and second load wheel assemblies (only the first assembly 210a is illustrated in FIG. 11), which assemblies are constructed in the same manner as the first and second assemblies 210a and 210b provided on the truck 100.

It is believed that the weight of the fork weldment 2000 and any load thereon will be sufficient to cause the fork weldment 2000 to return to its lowermost position when commanded by an operator. However, it is contemplated that a small amount of weight, e.g., 100-200 pounds, may be coupled to the fork weldment 2000 so as to ensure that it falls under the force of gravity when 0 or a minimal load is on the forks and commanded by an operator.

1. A pallet truck comprising:
a power unit including an operator's compartment, and a battery compartment;
a fork lifting mechanism coupled to said power unit; and
a fork assembly including a fork weldment coupled to said fork lifting mechanism, said fork weldment comprising a pair of forks, each of said forks having a working length so as to be capable of supporting at least two pallets substantially in-line with one another.

2. A pallet truck as set forth in claim 1, wherein each of said forks has a longitudinal axis and a working length extending from a backrest along its longitudinal axis of about 140 inches.

3. A pallet truck as set forth in claim 1, wherein said fork weldment further comprises a fork support structure coupled to said fork lifting mechanism, each of said forks being coupled at a first end to said fork support structure.

4. A pallet truck as set forth in claim 3, wherein said fork lifting mechanism comprises:
first structure fixedly coupled to said power unit;
a four bar linkage assembly coupled to said power unit and said fork support structure; and
a piston/cylinder unit coupled to said first structure and said fork support structure for effecting movement of said fork weldment relative to said first structure.

5. A pallet truck as set forth in claim 3, wherein said fork support structure functions to maintain said forks in a desired physical orientation relative to one another and has a length of no more than about 12 inches such that the overall length of the truck in the machine direction is limited.

6. A pallet truck as set forth in claim 3, wherein said fork support structure functions to maintain said forks in a desired orientation relative to one another and has a length in a machine direction of no more than about 10 inches such that the overall length of the truck in the machine direction is limited.

7. A pallet truck as set forth in claim 3, wherein said fork assembly further comprises at least one load wheel coupled to a second end of each of said forks, and linkage rod assemblies responsive to said fork lifting mechanism for causing said second ends of said forks to be raised between upper and lower positions.

8. A pallet truck as set forth in claim 1, wherein said power unit further comprises a drive motor compartment and a hydraulic motor compartment.

9. A pallet truck as set forth in claim 8, wherein a traction motor/brake assembly is housed in said drive motor compartment, a hydraulic motor/pump assembly is housed in said hydraulic motor compartment and a battery is housed in said battery compartment.

10. A pallet truck as set forth in claim 1, wherein said forks are capable of receiving a load up to about 15,000 pounds.

11. A pallet truck as set forth in claim 1, wherein each of said forks has a longitudinal axis and a working length extending from a backrest along its longitudinal axis of about 96 inches.

12. A pallet truck comprising:
a power unit including an operator's compartment and a battery compartment;
a fork lifting mechanism coupled to said power unit; and
a fork assembly including a fork weldment coupled to said fork lifting mechanism, said fork weldment comprising a pair of at least double-length forks capable of supporting up to about 15,000 pounds.

13. A pallet truck as set forth in claim 12, wherein each of said forks has a longitudinal axis and a working length extending from a backrest along its longitudinal axis of about 140 inches.

14. A pallet truck as set forth in claim 12, wherein said fork weldment further comprises a fork support structure coupled to said fork lifting mechanism, each of said forks being coupled at a first end to said fork support structure.

15. A pallet truck as set forth in claim 14, wherein said fork lifting mechanism comprises:
first structure fixedly coupled to said power unit;
a four bar linkage assembly coupled to said power unit and said fork support structure; and
a piston/cylinder unit coupled to said first structure and said fork support structure for effecting movement of said fork weldment relative to said first structure.

16. A pallet truck as set forth in claim 14, wherein said fork support structure functions to maintain said forks in a desired orientation relative to one another and has a length of no more than about 10 inches such that the overall length of the truck in the machine direction is limited.

17. A pallet truck as set forth in claim 14, wherein said fork assembly further comprises at least one load wheel coupled to a second end of each of said forks, and linkage rod assemblies responsive to said fork lifting mechanism for causing said second ends of said forks to be raised between upper and lower positions.

18. A pallet truck as set forth in claim 12, wherein said power unit further comprises a drive motor compartment and a hydraulic motor compartment.

19. A pallet truck as set forth in claim 18, wherein a traction motor/brake assembly is housed in said drive motor compartment, a hydraulic motor/pump assembly is housed in said hydraulic motor compartment and a battery is housed in said battery compartment.

20. A pallet truck as set forth in claim 12, wherein each of said forks has a longitudinal axis and a working length extending from a backrest along its longitudinal axis of about 96 inches.

21. A pallet truck as set forth in claim 12, wherein said forks comprise triple-length forks.

22. A pallet truck comprising:
a power unit including an operator's compartment having structure allowing an operator to sit while in said operator's compartment;
a fork lifting mechanism coupled to said power unit; and
a fork assembly including a fork weldment coupled to said fork lifting mechanism, said fork weldment comprising a pair of at least double length forks.

23. A pallet truck as set forth in claim 22, wherein each of said forks has a longitudinal axis and a working length extending from a backrest along its longitudinal axis of about 140 inches.

24. A pallet truck as set forth in claim 22, wherein said fork weldment further comprises a fork support structure coupled to said fork lifting mechanism, each of said forks being coupled at a first end to said fork support structure.

25. A pallet truck as set forth in claim 24, wherein said fork lifting mechanism comprises:
first structure fixedly coupled to said power unit;
a four bar linkage assembly coupled to said power unit and said fork support structure; and
a piston/cylinder unit coupled to said first structure and said fork support structure for effecting movement of said fork weldment relative to said first structure.

26. A pallet truck as set forth in claim 24, wherein said fork support structure functions to maintain said forks in a desired orientation relative to one another and has a length of no more than about 10 inches such that the overall length of the truck in the machine direction is limited.

27. A pallet truck as set forth in claim 22, wherein said power unit further comprises a drive motor compartment, a battery compartment and a hydraulic motor compartment.

28. A pallet truck as set forth in claim 27, wherein a traction motor/brake assembly is housed in said drive motor compartment, a hydraulic motor/pump assembly is housed in said hydraulic motor compartment and a battery is housed in said battery compartment.

29. A pallet truck as set forth in claim 22, wherein each of said forks has a longitudinal axis and a working length extending from a backrest along its longitudinal axis of about 96 inches.

30. A pallet truck as set forth in claim 22, wherein said forks comprise triple-length forks.
